(19) United States
(12) Patent Application Publication
(10) Pub. No.: US 2005/0131769 A1
(43) Pub. Date: Jun. 16, 2005

(54) System for operating a distributor organization utilizing supplier-maintained and distributor- selected websites

(76) Inventors: Timothy J. Flynn, Key Largo, FL (US); Thomas E. Flynn, Crystal Lake, IL (US); Patrick J. Flynn, Redlands, CA (US)

Correspondence Address: PAULEY PETERSEN & ERICKSON, 2800 WEST HIGGINS ROAD, SUITE 365, HOFFMAN ESTATES, IL, 60195, US

(21) Appl. No.: 10/734,095

(22) Filed: Dec. 11, 2003

(51) Int. Cl. G06F 17/60

(52) U.S. Cl. 705/26

(57) ABSTRACT

A system allows a product supplier to maintain a distributor organization which provides low transaction costs throughout the sales chain. The system provides each distributor with a subdomain web site available to consumers within a domain controlled by a product supplier server. The distributor website provides a means for providing information to, and taking orders from, consumers wishing to buy the product supplier products. The distributor website is based on a modifiable website template provided by the product supplier and is customizable to a certain extent whereby the distributor may choose options to modify the website. The distributor website is connected to a product supplier computer whereby product supplier business software and hardware maintain distributor information and provide transactional functions for the commercial chain, such as order taking, taxation, collection, and product shipping which can be performed directly by the product supplier. The distributor may track sales and request commission payments through a secure area of the subdomain website.

### BACKGROUND OF THE INVENTION

Increasingly, what were once niche markets within the sphere of commercial sales have been consolidated into large specialty retailer chains. The large specialty retailer chains are also challenged by the large mass market discount chains. For example, in the field of office supplies, there are specialty retailer chains such as Office Max, Office Depot, and Staples. Large mass market discount chains such as Walmart, Target, and the like may further challenge the office supplies retail niche with large offerings of office supplies at low prices.

The smaller volume, customer-interaction oriented retailer or distributor thus may have to compete with these large retail chains on price even though the smaller volume distributor may offer superior specialty products and an enhanced level of customer service. In order to stay in business, a product supplier, such as an original equipment manufacturer (OEM) or the like, and the distributors for the product supplier, need to minimize transaction costs for each small volume transaction at each level of the supply chain, i.e., between distributor and product supplier, and between distributor and end user or consumer. It would thus be desirable if the transaction costs could be lessened for an entire distributor organization through intelligent use of electronic business methods. However, not all small volume distributors are willing or able to gain the expertise and absorb the costs of maintaining an electronic commerce outlet, such as a web-site, merely to compete on a small scale with the large retail chains.

Thus, there is a need for product suppliers to encourage specialty distributor participation in electronic commerce such as web sales or the like to gain the efficiencies for all parties in the commercial chain.

### SUMMARY OF THE INVENTION

To answer the need for the reduction in transaction costs necessary to compete in a large-retailer dominated market, the present invention provides a system by which the niche or specialty product supplier can maintain a distributor organization with reduced transaction costs. Aspects of the present invention offer viable electronic commerce options for the distributors at low cost. A system of subdomain electronic commerce sites, sometimes referred to herein as “websites” for ease of explanation, with central control by the product supplier are offered free to the distributor while maintaining low cost to the product supplier. While presented for exemplary purposes in the sphere of Internet or world wide web network environments, it will be appreciated that private networks, sub-networks, or the like may be utilized as necessary for all or part of the commercial transaction chain.

According to certain aspects of the present invention, a product supplier such as an OEM manufacturer or the like, can maintain a distributor network which allows each distributor, also sometimes referred to as a reseller or dealer, to have an electronic commerce site within the product supplier domain. The product supplier domain server provides for subdomain distributor websites based on a modifiable template to provide for transactions between the distributor and his customers, also sometimes called end users or consumers, wishing to buy the product supplier products. The distributor website is modifiable or customizable to a certain extent whereby the distributor may choose, e.g., which products to sell on the web site, which mark-ups are to be added to the offered products, what additional information is to be added into defined spaces of the website, and how to customize the look and feel of the website within parameters set by the product supplier. Many such items may be customized within the parameters defined by the product supplier.

The distributor subdomain electronic commerce site can be connected to various product supplier business software applications and hardware, to provide for the transactional functions of the commercial chain, e.g., distributor databases for distributor organization management, automation for product order fulfillment functions, such as order taking, taxation, collection, and product shipping to be fulfilled by the product supplier, and commission accounting and tracking. The distributor may then request or automatically receive payment from the product supplier for the transactions conducted through the distributor website. Thus, the distributor is free to concentrate on the human interaction aspects of the distributor's business. The product supplier, by providing the distributor subdomain electronic commerce sites in template form within the product supplier domain, is able to efficiently provide its distributors with such websites and connect the distributor websites to the business or transactional functionalities provided by the product supplier.

Functionally, all information at the distributor website may be interconnected through the product supplier domain server to the product supplier business software and hardware to maintain distributor information and to provide for transactional functions of the commercial chain. The domain server and the product supplier computer may reside in the same equipment pieces or be distributed between various equipment pieces as would be understood by those of skill in the art.

Discussion of hardware and software modules or applications will thus be given herein with respect to specific functional tasks or task groupings that are in some cases arbitrarily assigned to the specific modules or applications for explanatory purposes. It will be appreciated by the person having ordinary skill in the art that aspects of the present invention may be arranged in a variety of ways, or that functional tasks may be grouped according to other nomenclature or architecture than is used herein without doing violence to the spirit of the present invention.

### BRIEF DESCRIPTION OF THE DRAWINGS

FIG. 1 shows aspects of the present invention in diagram form.

FIG. 2 is a flow chart illustrating various aspects of the distributor organization operation.

FIG. 3 shows aspects of the present invention in diagram form.

FIG. 4 is a flow chart illustrating further aspects of the distributor organization operation.

### DETAILED DESCRIPTION OF THE PREFERRED EMBODIMENTS

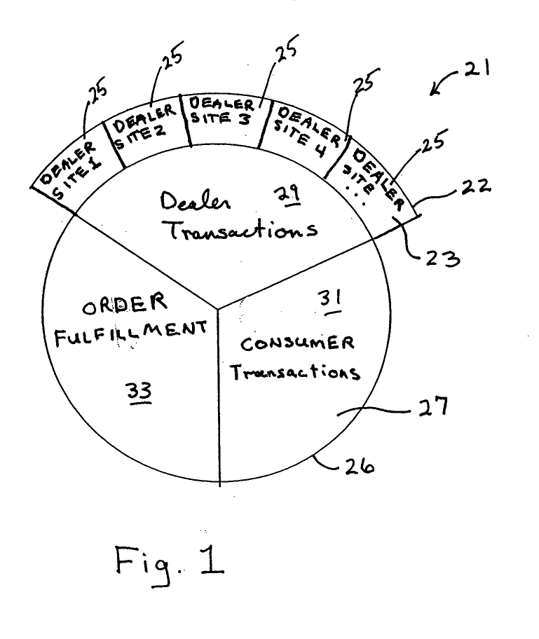

Referring to FIG. 1, a simplified block diagram of basic components for a distributor organization 21 includes an outer ring 22 representing the product supplier domain server 23 which controls and contains the distributor or dealer subdomain sites, collectively 25. An inner circle 26 represents the product supplier computer 27 containing the business software applications necessary for the transactional aspects of the commercial chain. The business software applications within the product supplier computer 27 are subdivided in FIG. 1, by way of example, into three categories including dealer transactions 29, consumer transactions 31, and order fulfillment 33, as further explained below. The product supplier computer 27 and the product supplier domain server 23 may comprise the same computer unit or any type or amount of hardware, e.g. CPUs, databases, communications lines, memory units, etc., necessary to complete the desired functionality of the system to which the present invention is put. Physical arrangement of such components and their interactive operability is considered to be within the ordinary skill in the art. The product supplier computer 27 and the product supplier domain server 23 will be referred to herein as “under the control of” of the product supplier, meaning that the product supplier does not necessarily need to literally own or possess the physical systems but merely needs to be able to direct their functioning in the desired manner.

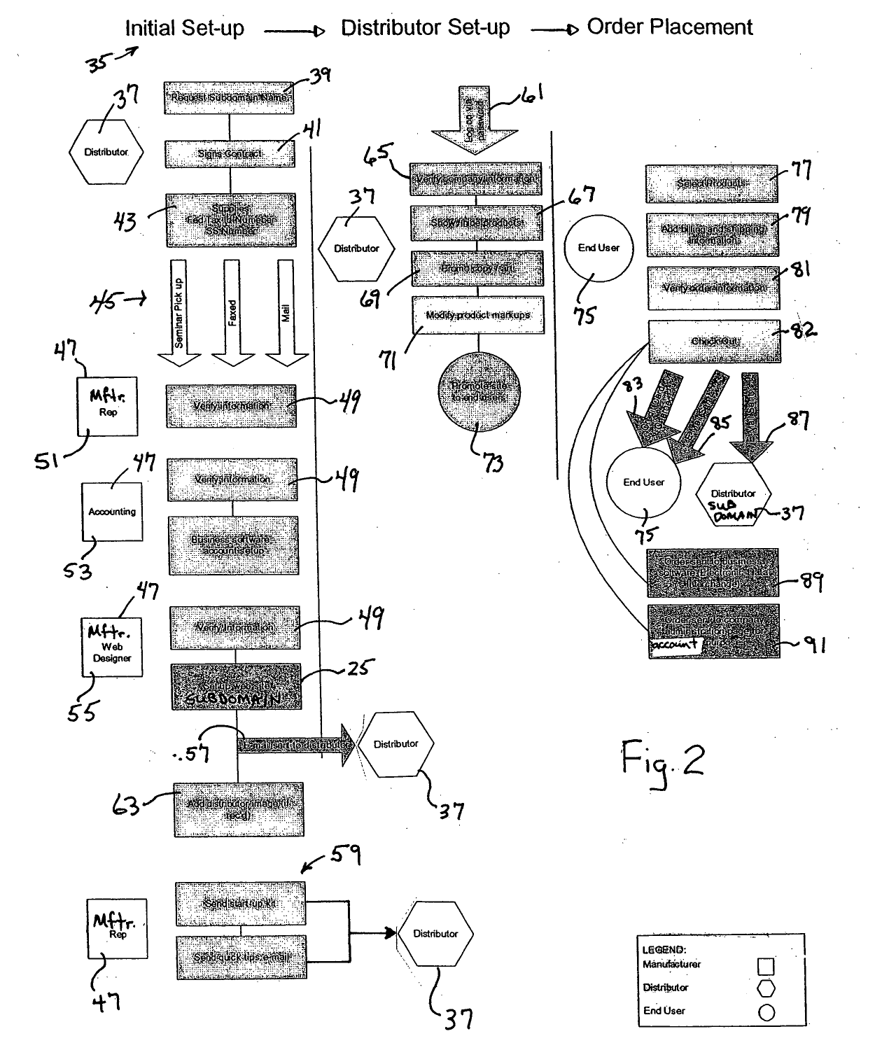

Referring to FIG. 2, a flow chart of the distributor organization operation starts with initial set up 35 of the distributor function. As indicated, the distributor 37 will submit a request as at 39 for a subdomain name and attendant electronic commerce site, also sometimes referred to as a “web site” for simplicity, to the product supplier, which controls the upper level domain 23 containing the subdomain web sites 25 (FIG. 1). The distributor will submit all identification details necessary for, or desired by, the product supplier to establish the distributor's business qualifications and to track and conduct business between the distributor and the product supplier. At or about this time the distributor and product supplier may further execute a contract as at 41 governing the terms of their relationship. The distributor 37 will also supply all necessary identifying information as at 43 to the product supplier 47 by any necessary or desired means 45 whether electronic or hard copy. In the exemplary flow chart, three different units of the product supplier will then verify as at 49 the distributor information for accuracy and completeness, namely an account representative 51 interfacing with the distributor who may enter the distributor information into a distributor database for informational purposes, the central accounting function 53 of the product supplier which may enter the distributor information into all business software applications necessary to administer all transactional matters with the distributor, and the website designer or administrator 55 who may enter the distributor information into the domain server 23 (FIG. 1) as necessary to initially create the distributor's subdomain website 25. Notice may then be sent as at 57, preferably electronically such as by email, to the distributor, that a subdomain website is available for the distributor. Any additional information or material as necessary or desired may then be sent as at 59 from the product supplier 47 to the distributor 37 by the appropriate method. For example, sales brochures, business cards, product samples or the like may be shipped to the distributor.

Referring to the second column, or phase, of the flow chart of FIG. 2, the distributor will then be able to access a secure area of his modifiable personal subdomain website via a password 61 supplied by the product supplier. The distributor's personal subdomain website will be in the form of a modifiable template and will be set up as at 63 to contain basic indicia identifying the distributor, such as logos, name, business address, contact information, etc., as input to the subdomain website 25 during initial set up by the product supplier. The distributor 37, when in the secure area, can then verify the information as at 65 on the modifiable website; and further modify the website template, e.g., by selecting or deselecting which of the product supplier products will be offered for sale through the distributor website as at 67, by adding individualized promotional copy and art work as at 69, and by modifying the product markup percentage as at 71 on the product supplier products offered to determine listed selling prices on the website. The website is then ready to be made publicly available to the end users or customers of the distributor as at 73.

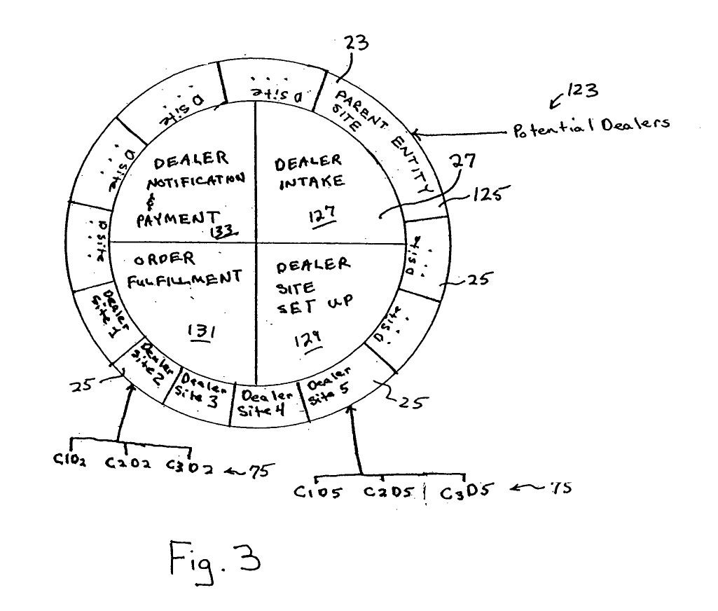

Referring also to FIG. 3 and to the third column, or phase, of the flow chart of FIG. 2, the end users or customers, collectively 75, will then be able to access the dealer or distributor subdomain website 25 via the subdomain network identifier, or address, which may, e.g., be a URL with the upper domain 23 of the product supplier in the address, over the world wide web. The customer 75 may then select products 77 offered over the dealer sites 25. The customer 75 will then supply billing and shipping information 79 such as credit card information and the address to which the product is to be shipped. The business software applications of the product supplier provided to enable order fulfillment 33 may then confirm customer payment such as by verifying the customer credit information is valid, i.e., confirming that the consumer's credit is suitable for completing the transaction as at 81, and initiate check out procedures as at 82 including notifying the end user 75 that his credit card has been charged as at 83 such as by an email as at 85. An email will also be sent as at 87 to the distributor 37, e.g., to the secure area of his subdomain, as notification that sales activity has taken place through his subdomain 25. Further, the order information will be sent as at 89 to the order processing department of the product supplier 47 and will further be sent to the product supplier accounting function as at 91 to enable recordation and eventual payment to the dealer 37 of his commission on the sale.

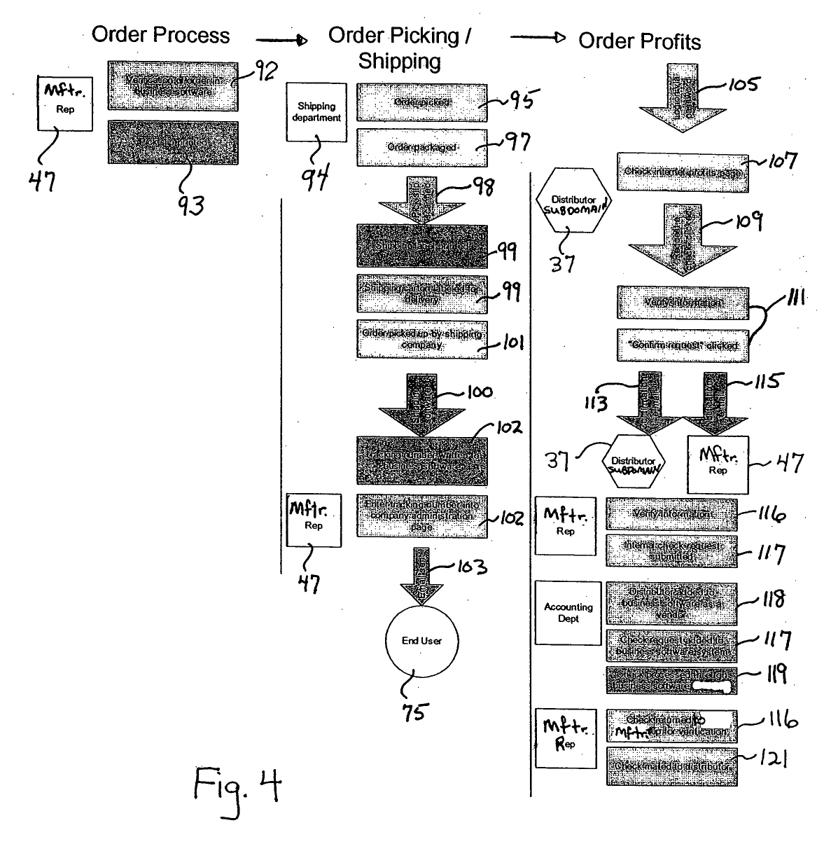

Referring to the flow chart of FIG. 4, the order information will arrive at the order processing department of the product supplier 47, be verified as at 92, and a “pick slip” will be generated as at 93 to enable the shipping department 94 to select the products ordered by the end user 75. That is, the order will be picked as at 95, then packed as at 97, by the product supplier shipping department, verified as at 98, appropriately addressed as at 99, and delivery responsibility will be assumed by a shipping company as at 101. The person having ordinary skill in the art will realize that various steps prior to physical shipping may be fully automated in certain business environments. Typically, a third party shipper will have package tracking software as at 100 and the end user's shipment will be assigned a tracking number which can be recorded as at 102 into the product supplier business software applications for forwarding to the end user via email 103. Concurrently, the product supplier business software applications may post the relevant end user order information to the secure area of the distributor's subdomain website 25 (FIG. 1) if this has not been previously done.

Referring to the third column, or phase, of the flow chart of FIG. 4, the distributor 37 may enter as at 105 the secure area of his subdomain website through use of his password 61. Contained in the secure area is a page with an account of the distributor's commissions 107. The distributor may then request payment as at 109 of his commissions through a form accessed through the commissions page. The product supplier may limit the amount or frequency of the payment requests if desired. Once the payment request has been verified and confirmed as at 111 by the distributor, a responsive email as at 113 will inform the distributor that his request has been received and notification of the request will be sent as at 115 to the product supplier accounting function for processing. Various manual or automatic procedures, including redundancy checks and safeguards as at 116, distributor database management as at 118 and the like may be performed by the product supplier at this stage to process the check request as at 117, cut the check to the distributor as at 119 and have it mailed as at 121.

Referring again to FIG. 3, it will thus be seen that the product supplier domain server 23 and the parent computer 27 can enable and control the operation of the distributor subdomain websites 25 through which electronic commerce may be conducted with the distributor's customers, collectively 75. As shown, Dealer Site 2, i.e., the subdomain site for a distributor identified as “2”, will accept requests for Distributor 2's customers, C1, C2, and C3. Dealer Site 5, i.e., the subdomain site for a distributor identified as “5”, will accept requests for Distributor 5's customers, C1, C2, and C3. The dealers or potential dealers 123 may request dealer status and a subdomain website from the product supplier through a product supplier web site 125 which may be made available only to qualified persons. The product supplier computer 27 may be equipped with hardware and software functionality to perform all dealer communication and tracking functions, as at 127, through any of various commercially available business or enterprise software packages suitable for the product supplier business functionalities. For example, such business applications software may be available from PeopleSoft of Pleasanton, Calif.; J. D. Edwards of Denver, Colo., Cognos of Ottawa, ON; or Datex, Corporation of Clearwater, Fla. Dealer site set up and maintenance functionality, 129, will control the management of the templated subdomains which are modifiable at dealer request. The dealer website functionalities and the business software functionalities will be linked as necessary for the efficient management of the virtual dealer network. Further major functional groupings of the business software package may include order fulfillment functionalities 131 for efficient processing of customer orders received through the dealer websites and the dealer notification and payment functionalities 133 necessary for communication with, and payment to, the dealers.

While certain exemplary embodiments have been put forth to illustrate the present invention, these embodiments are not to be taken as limiting to the spirit or scope of the present invention which is defined by the appended claims.

1. Software for operating a distributor organization of a product supplier to provide for sales of a product supplier product by distributors of the product supplier product comprising:
a) website software applications for operating a domain server under control of the product supplier to provide a plurality of subdomain websites for distributors to offer sales of product supplier product to consumers;
b) business software applications for providing business functionalities including:
i) managing distributor transactions between the product supplier and the distributor,
ii) managing consumer transactions between the distributor and the consumer, and
iii) managing order fulfillment transactions between the consumer and the product supplier; and
c) the website software applications and the business software applications being interconnected whereby the product supplier may accept and fulfill sales orders from consumers placed through the subdomain websites.

2. The software of claim 1 wherein: the distributor transactions include enabling a distributor to request commission payment through a subdomain website.

3. The software of claim 1 wherein: the website software enables a distributor to modify a subdomain website assigned to the distributor.

4. A system for operating a distributor organization of a product supplier to provide for sales of a product supplier product by distributors of the product supplier product comprising:
a) a domain server under control of the product supplier providing a plurality of subdomain websites for distributors to offer sales of product supplier product to consumers;
b) a computer under control of the product supplier having applications for providing:
i) distributor transactions between the product supplier and the distributor,
ii) consumer transactions between the distributor and the consumer, and
iii) order fulfillment transactions between the consumer and the product supplier; and
c) the domain server and the computer being interconnected whereby the product supplier may accept and fulfill sales orders from consumers placed through the subdomain websites.

5. The system of claim 4 wherein: the distributor transactions include maintaining a database of distributor identifier information.

6. The system of claim 4 wherein: the domain server provides means for a distributor to modify a subdomain website assigned to the distributor.

7. The system of claim 4 wherein: the distributor transactions include maintaining a listing of distributor sales made and commissions earned through the subdomain websites.

8. The system of claim 4 wherein: the distributor transactions include enabling distributors to request commission payments through the subdomain websites.

9. The system of claim 4 wherein: the order fulfillment transactions include accepting consumer orders placed through the subdomain website, verifying customer payment and notifying a product supplier shipping department that the consumer order is to be shipped.

10. A system for operating a distributor organization of a product supplier to provide for sales of a product supplier product by distributors of the product supplier product comprising:
a) a domain server under control of the product supplier;
b) a computer under control of the product supplier,
c) the computer and the domain server being interconnected and having software applications therein for providing functionalities including:
i) a distributor intake functionality for entering distributor identification details and maintaining a database of the distributor identification details,
ii) a distributor web site set up functionality for providing a distributor with a modifiable personal web site and enabling the distributor to make at least one of changes or additions to the modifiable website,
iii) a consumer order process functionality enabling consumers to place orders for product supplier products and pay for the orders through the modifiable website and maintaining records of the orders,
iv) an order fulfillment functionality for providing instructions to the product supplier with respect to order fulfillment of consumer orders by the product supplier, and
v) a distributor notification functionality for listing consumer orders placed through the modifiable website and fulfilled by the product supplier; and for figuring the commission of the distributor;
d) whereby a plurality of dealers can each create a modified website for taking consumer orders of the product supplier product, the product supplier can fulfill the consumer orders, and the product supplier and the distributor can track orders and commissions of the distributor.

11. The system of claim 10 further including a functionality for providing payment of commissions to the distributor.

12. The system of claim 10 wherein the order fulfillment functionality provides instructions for boxing and addressing of a consumer order.

13. The system of claim 10 wherein the distributor web site set up functionality allows the distributor to select a password for entering a secure area of the personal web site.

14. The system of claim 10 further including a functionality whereby the distributor can modify a template of product supplier products offered on the personal web site.

15. The system of claim 10 further including a functionality whereby the distributor can modify the personal web site to individualize promotional copy, add additional distributor product offerings, and select product supplier product markups.

16. The system of claim 13 further including a functionality whereby the distributor can view customer orders and commissions at the secure area of the personal website and submit commission payment requests to the product supplier at the secure area of the personal web site.

17. The system of claim 10 whereby the consumer orders are taken from the personal website and fulfilled by the product supplier.

18. The system of claim 10 further including a functionality whereby a tracking number is applied to a consumer order and the consumer is notified of the tracking number.

19. The system of claim 10 further including a functionality whereby the personal web site allows the consumer to submit consumer payment information and verification of the consumer payment information is provided to the product supplier.

20. The system of claim 10 further including a functionality whereby the distributor web site lists a shipping status of the consumer order.

21. The system of claim 10 further including a functionality whereby commission payment requests are submitted to the product supplier from the personal web site.

22. The system of claim 21 further including a functionality whereby payment is provided to the distributor.

23. The system of claim 21 whereby the product supplier can set dollar amount limits or payment frequency limits, or both, on commission payment requests of the distributors.
